(19) United States
(12) Patent Application Publication
(10) Pub. No.: US 2005/0098138 A1
(43) Pub. Date: May 12, 2005

(54) Diesel four cycle, 1 poppet valve, modified head, piston and valves

(76) Inventor: Charlie Clyde Sanders, Houston, TX (US)

Correspondence Address: CHARLIE C. SANDERS, 11235 STROUD DR., HOUSTON, TX, 77072, US

(21) Appl. No.: 10/354,205

(22) Filed: Jan. 30, 2003

Related U.S. Application Data
(60) Provisional application No. 60/411,112, filed on Sep. 16, 2002.

(51) Int. Cl. F02F 1/00

(52) U.S. Cl. 123/193.6

(57) ABSTRACT

The invention comprises the cylinder head, equipped with stationary lobes; a piston crown with lobes that mesh with the stationary lobes, without contact, to create turbulence in the combustion chamber, and rotary valves that manipulate movement of compressed air and exhaust gases in the combustion chamber and manifold; creating a mixture of air and fuel for more complete combustion with less recycled exhaust gases, and the improved design combustion chamber being cylinder shaped and adaptable to four cycle diesel engines is equipped with one poppet valve that when closed causes rotary valves to direct compressed air through the manifold for cooling purposes and when open, the cylinder, combustion chamber and manifold become a conduit for exhaust gases until piston movement ceases to move exhaust gases, then compressed air assumes exhaust gas movement purging the combustion chamber and manifold as piston movement downward begins the intake stroke.

### DETAILED DESCRIPTION

The invention is constructed of material of sufficient strength to withstand the forces that are inherent to diesel engines, and for this application an overhead camshaft²³ is used along with a supercharger³⁰ providing compressed air. Clockwise rotation is chosen for this application although counter clockwise will function after redesigning the cylinder head. The poppet valve, valve seat valve stem and valve head are all prior art.

The following description first describes the valves and manifold, and their function, then follows in the order of compression, combustion, exhaust, purge of exhaust gases, intake and cooling. The air guide is constructed within the manifold and is discussed following the valves.

Preferred embodiments of the instant invention include a modified piston crown and cylinder head, and includes rotary valves, one poppet valve, and an air guide constructed into the manifold. The cylinder block with one or more cylinder is vertical to the cylinder block base which is horizontal and contains a crankshaft mounted horizontal for vertical movement of a piston and pivotal connecting rod, connected to the crankshaft. The modified cylinder head is secured to the cylinder block above the cylinder bore, with the modified piston installed in a conventional manner to form the combustion chamber. A diesel fuel injector is installed into a cylinder head lobe, and an overhead camshaft is mounted above, and to, the poppet valve for vertical movement on the vertical axis of the piston. The above embodiments comprise a four cycle internal combustion engine.

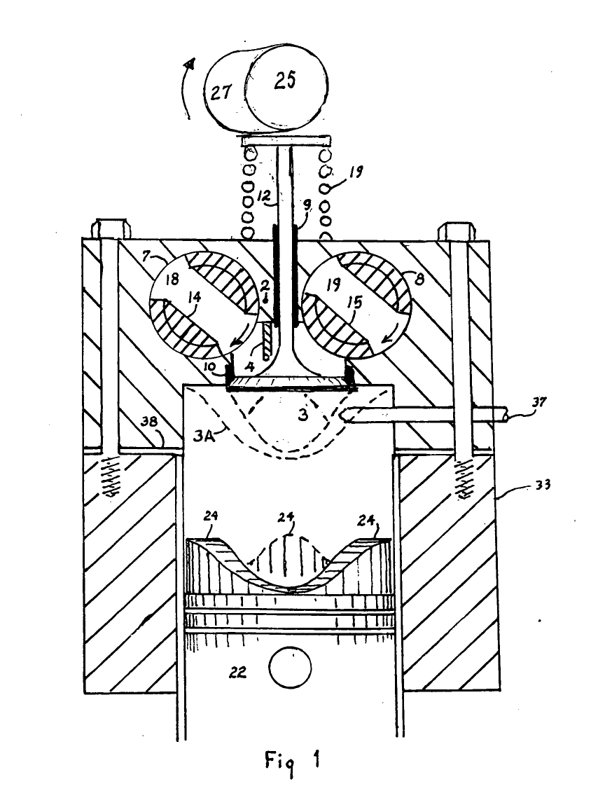

FIG. 1 is a front view sectional of the cylinder head¹ at the poppet valve¹¹ to show the overall invention except for the lobes³ designed into the cylinder head,¹ the super charger,³⁰ and exhaust pipe.³ A turbocharger will supply compressed air, but for this application the word “supercharger³⁰ will be used. The rotary valves^{14,15} are timed to complete one revolution, for two revolutions of the crankshaft and the poppet valve¹¹ functions one time for two revolutions of the crankshaft.

During compression and combustion the poppet valve¹¹ is closed, isolating the rotary valves.^{14,15} Rotary valves^{14,15} are then used in cooling the cylinder head¹ during the compression and combustion strokes.

The diesel fuel injector³⁷ is installed through, and to any cylinder head lobe.³ The lobes of the piston crown²⁴ are identical to the lobes³ designed into the cylinder head.¹ The piston²² and cylinder head lobes³ are of a hill and valley design. When the hill of a piston lobe is inverted, it is identical to the design of the valley³⁴ between any two lobes of the piston crown²², or cylinder head¹. Rotary valve^{14,15} bodies are of a cylinder shape of a certain diameter, installed in a passageway^{7,8} of larger diameter, with minimum clearance. The valve bodies are open on one end for intake of compressed air, and an outlet on one side, forming the port opening that is designed identical to the passageway port opening that is stationary in the cylinder head. A shaft^{16,17} of smaller diameter is constructed to the opposite end of the valve body^{14,15} from the air inlet, and installed thru the cylinder head passageway,^{7,8} shaft first, into a drilled hole of appropriate size and connected to a means of rotating the shaft. The design of the port^{18,19} is described as a horizontal line of known length, connected at each end by a curved line of longer length, forming an arch.

Another port,^{34,35} for internal cooling of the cylinder head is constructed into the valve body of both intake and exhaust valves.^{14,15} The design of cooling ports is optional. Cooling ports are to extend the flow of air for a longer duration allowing a larger volume of air to pass through the ports. As an option, the cooling port openings can be constructed as an extension of the compressed air port^{18,19} opening, because the poppet valve¹¹ closing ends the intake stroke, and the poppet valve¹¹ opening begins the exhaust stroke. The poppet valve¹¹ closing separates the manifold³² from the combustion chamber.⁴¹

The timing point for the intake rotary valve¹⁴ to open is when the straight edge of the port¹⁸ opening begins to uncover the straight edge of the passageway port⁵ at approximately 45° before top dead center. This timing point is determined by how late in the exhaust stroke the intake rotary valve will open, and meet the least amount of resistance between outgoing gases and incoming compressed air. Adjusting the timing point is by adjusting the intake rotary valve¹⁴ to the camshaft,²⁷ which is timed to the crankshaft. The open duration of the valve is 225° crankshaft rotation.

The curved edge of the exhaust rotary valve,¹⁹ uncovering the curved edge of the exhaust passageway port,6 is the timing point for opening the exhaust rotary valve¹⁵ at bottom dead center, and the straight edge closes the valve at approximately 45° after top dead center.

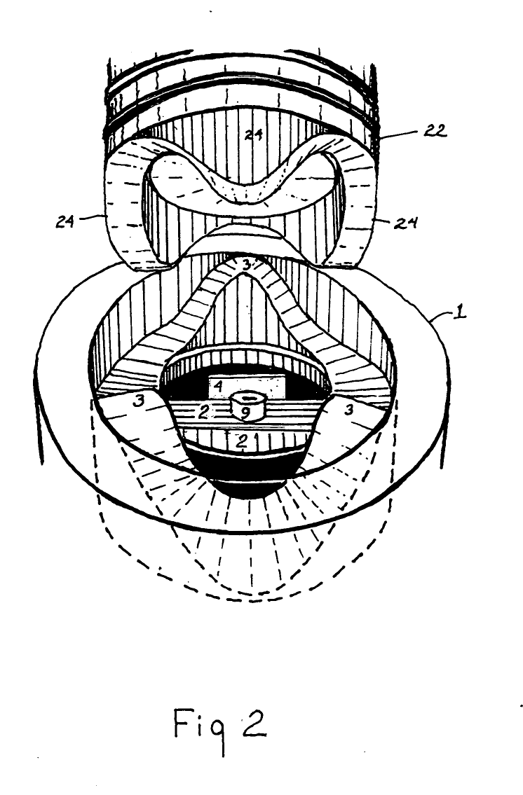

FIG. 2 was drawn at a 45° angle, piston²² angle to cylinder head,¹ and 45° viewer to cylinder head¹. In operation the piston²² is vertical to the cylinder head,¹ and the lobes²⁴ of the piston²² penetrate into the void³⁴ of the cylinder head¹ without contact. The piston²² and cylinder are on the same vertical axis.

The lobes^{3,24} are designed to merge, without contact, and expel compressed air into the combustion chamber to create turbulence on the compression stroke.

On the exhaust stroke, the poppet valve¹¹ is open and lobes³⁻²⁴ merge and expel exhaust gases into the manifold³² where compressed air purges exhaust gases into the exhaust rotary valve¹⁵ and atmosphere.

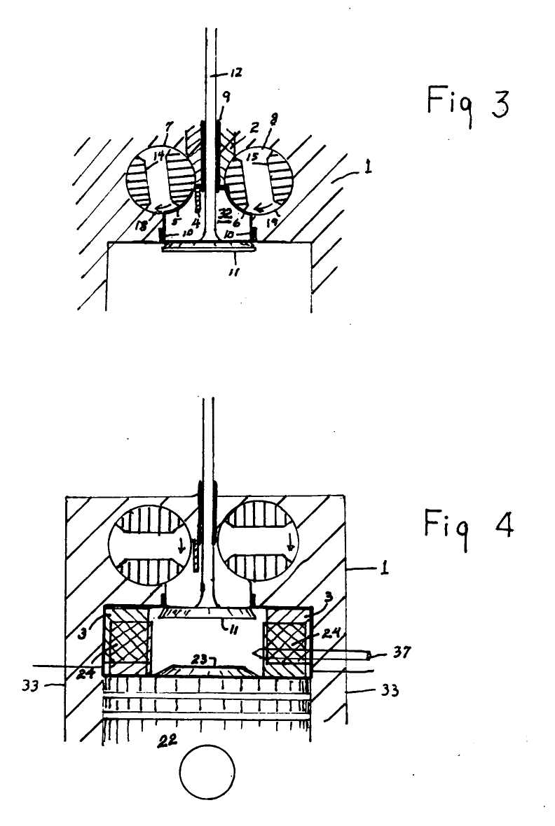

FIG. 3 is the manifold³² of valves, highlighted in dark outline. The area between the poppet valve head when closed, and the two rotary valves^{14,15} and includes the two rotary valve ports,^{5,6} the valve seat,¹⁰ valve guide,⁹ valve guide support,² and intake air guide.⁴ The intake air guide⁴ directs air toward the poppet valve head¹¹ to prevent air from assuming the path of least resistance into the exhaust port⁶ without purging exhaust gases. At the poppet valve head,¹¹ air turns, assuming a timed position behind final exhaust gases forced from between piston lobes²⁴ and cylinder head lobes,³ and force exhaust gases into the exhaust rotary valve¹ and atmosphere.

FIG. 4 is the combustion chamber which is formed by the poppet valve head,¹¹ cylinder head lobes,³ piston crown lobes,²⁴ and the piston crown.²³

Before top dead center, the Jet effect caused by merging lobes,^{3,24} forces air into the combustion chamber, creating turbulence in air that ignites diesel fuel, caused by the heat of compression, as it is injected into the combustion chamber.

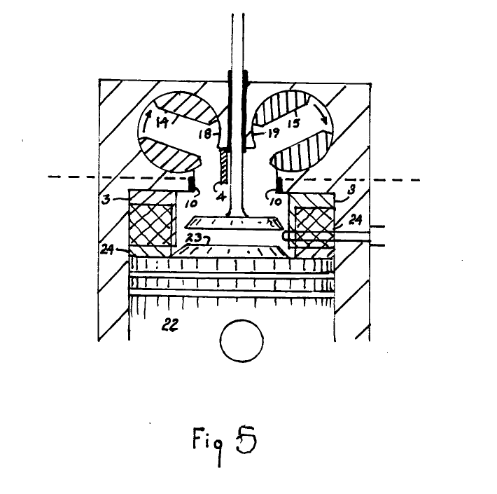

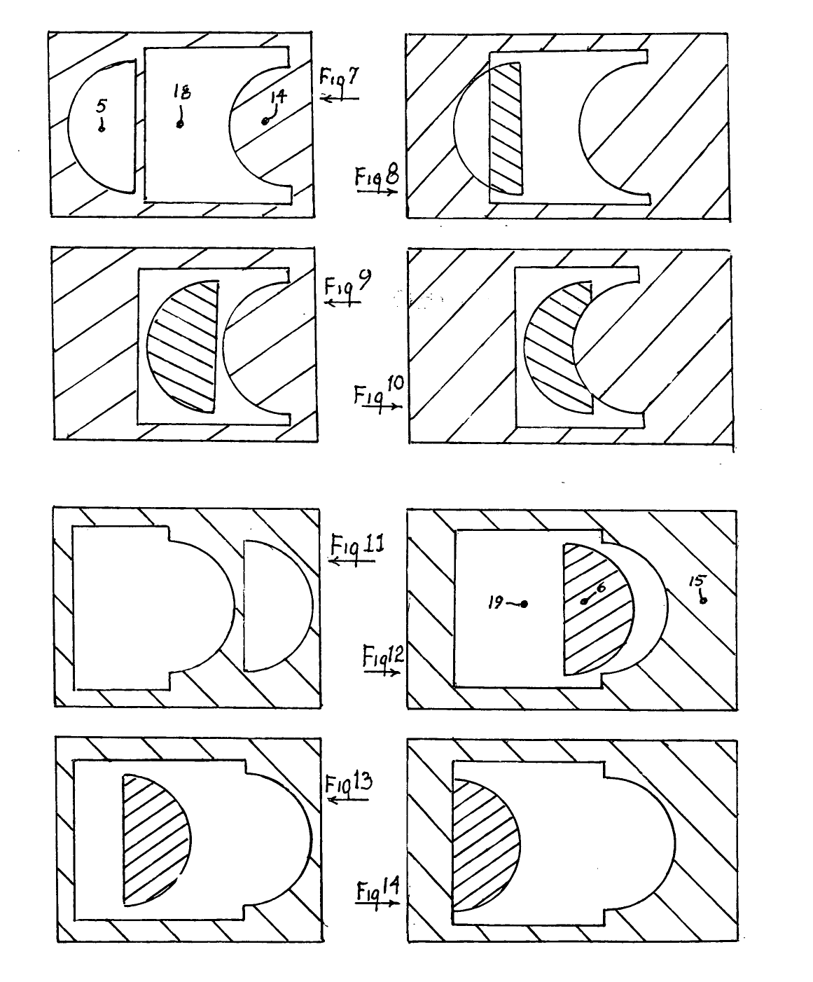

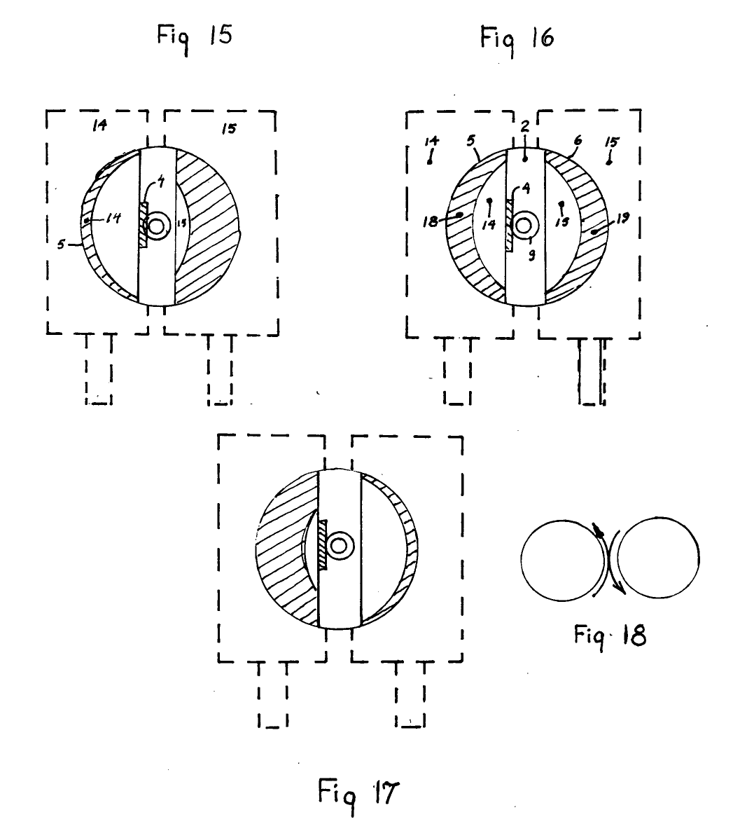

FIG. 5 is the combustion chamber⁴¹ when the poppet valve¹¹ opens, uniting the combustion chamber⁴¹ and manifold³² to form the combustion chamber⁴¹ area. This illustration is at top dead center with all three valves open, during the purge of exhaust gases. FIG. 15 illustrates when the poppet valve¹¹ first opens causing the release of exhaust pressure from the cylinder⁴⁰ and combustion chamber⁴¹ into the manifold³² and exhaust rotary valve.¹⁵

### Air Guide

Compressed air, released from the intake rotary valve,¹⁴ travels around the air guide⁴ into the exhaust rotary valve¹⁵ forcing exhaust gases ahead, and into, the exhaust rotary valve.¹⁵ Air flow volume is controlled by designing vents into various positions in the air guide⁴ to prevent pockets of exhaust gases form forming in crevices around the air guide.⁴ The vents allow a specific volume of air to pass through to the exhaust rotary valve.

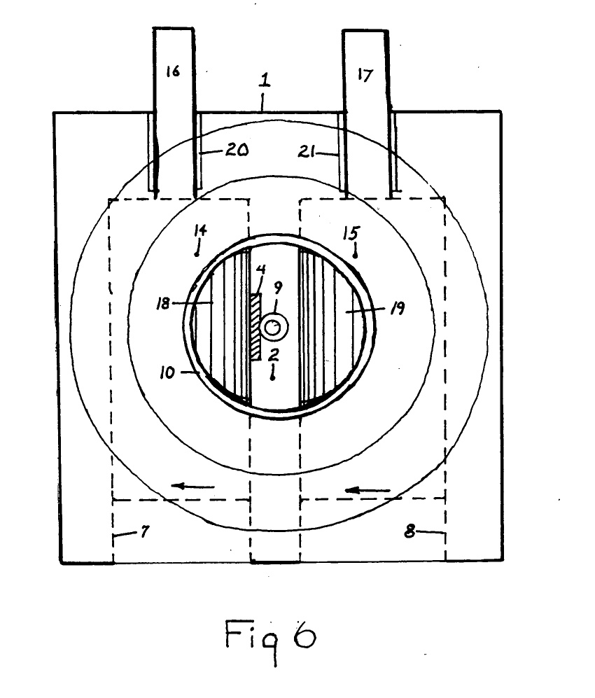

FIG. 6 is a bottom view of the cylinder head¹ looking upward into the venturi of the manifold,³² which is sectioned at the poppet valve seat.¹⁰ See FIG. 5 at the dotted line. The intake rotary valve port¹⁸ is on the same side of the valve guide support,² as the intake air guide.⁴ The intake rotary valve¹⁴ opens at approximately 45° before top dead center, as the straight edge of the valve port¹⁸ begins to uncover the intake port⁵ at the valve guide support,² next to the air guide.⁴ The intake rotary valve¹⁴ closes at bottom dead center as the curved edge of the intake valve port¹⁴ rotates past the opening point⁵ to meet the curved edge of the port,¹⁴ closing the valve.

### Compression

The combustion chamber is comprised of the piston lobes, cylinder head lobes, piston crown and poppet valve head. Piston movement upward increases compression as piston lobes rise into the void separating cylinder head lobes causing a jet of compressed air being expelled from the void between the approaching lobes, into the center of the combustion chamber. The jet effect causes turbulence in the combustion chamber, mixing fuel and air as fuel injection occurs.

### Combustion

Combustion begins with diesel fuel being injected into super-heated compressed air, causing combustion and turbulence that continues throughout the stroke, with resulting power transmitted to the crankshaft as in prior art. FIG. 14 shows the engine halfway through the combustion stroke. FIGS. 4 & 13 show the combustion chamber as injection occurs.

### Exhaust-Purge-Intake

The exhaust stroke begins when the poppet valve and exhaust rotary valve open in unison at bottom dead center, piston position, causing exhaust pressure to be released from the cylinder and combustion chamber into the manifold and exhaust rotary valve, creating a conduit for exhaust gases to escape into the atmosphere.

Piston movement upward causes the flow of exhaust gases to continue until approximately 45° before top dead center, piston position, at which point the intake rotary valve opens, releasing compressed air into the manifold directed by the air guide in an axial direction along the poppet valve stem toward the poppet valve head. Piston movement continues moving exhaust gases causing evacuation of most remaining exhaust gases from above and below the poppet valve head.

At top dead center, piston position, piston movement upward ceases to move exhaust gases. After top dead center, piston position, compressed air assumes movement of exhaust gases until approximately 45° after top dead center when the exhaust rotary valve closes. The intake rotary valve continues open until bottom dead center when the intake rotary and poppet valves close, in unison, ending the intake stroke; or, the intake rotary valve may remain open for internal cooling of the cylinder head.

The duration of port openings of the rotary valves is extended beyond one stroke of 180° as in prior art, to 225° to purge the combustion chamber of exhaust gases. This causes an overlap of valve openings when the intake valve opens at 45° before top dead center and the exhaust valve to close at 45° after top dead center, for a total of 90° overlap.

### Cooling

The rotary valves dual function during compression and combustion is in providing compressed air for internal cooling of the cylinder head.¹

First, piston movement forces exhaust gases through the manifold, causing metal surfaces of the cylinder head to become heated, then second, compressed air enters the manifold from the intake rotary valve¹⁴ before exhaust gases are completely purged. Compressed air absorbs heat by radiation from metal surfaces as it passes through the manifold, while pushing exhaust gases ahead, and into, the exhaust rotary valve¹⁵ and atmosphere.

After the exhaust rotary valve¹⁵ closes air continues to flow into the cylinder to complete the intake stroke, and compressed air, heated by the heated metal surfaces is useful in combustion. This means of cooling is intended to cool the cylinder head alone, or when combined with heat transfer by conduction.

Sheet 7

FIGS. 15, 16, 17 and 18 show a counter clockwise rotation, and all other drawings turn clockwise. In FIGS. 15, 16 and 17 air from the intake rotary valve¹⁴ proceeds to the poppet valve head¹¹ moving in an axial direction along the poppet valve stem.¹²

FIG. 15 indicates that counter clockwise rotation would cause air to make a 45° to 90° turn exiting the valve, turning, and proceeding toward the poppet valve head¹¹ whereas air exiting the valve in a clockwise rotation does not make a turn. Both clockwise and counter clockwise rotation are possible.

FIGS. 15, 16 and 17 show the valve positions as the combustion chamber is purged of exhaust gases at the end of the exhaust stroke and beginning of the intake stroke. FIGS. 18 indicates the direction of rotation of both rotary valves at the drive shaft end.

Sheet 8

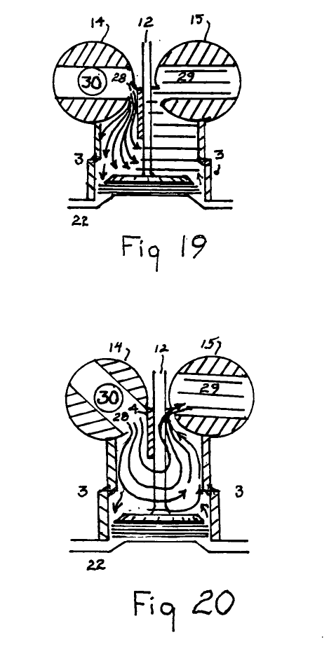

FIGS. 19 and 20 illustrate the means by which the supercharger³⁰ evacuates exhaust gases from the manifold. Compressed air is illustrated with curved arrows, and exhaust gases by straight, horizontal lines.

FIG. 19 is when the intake rotary valve¹⁴ is opening, and compressed air is moving through the intake port⁵ contacting the intake air guide⁴ which directs the air downward in an axial direction toward the poppet valve head. Exhaust gases, forced into the combustion chamber by the lobes,³ are forced around the air guide into the exhaust port.⁶

FIG. 20 illustrates the evacuation of exhaust gases almost complete as the exhaust rotary valve¹⁵ is almost closed. The intake rotary valve¹⁴ is open the remainder of the intake stroke.

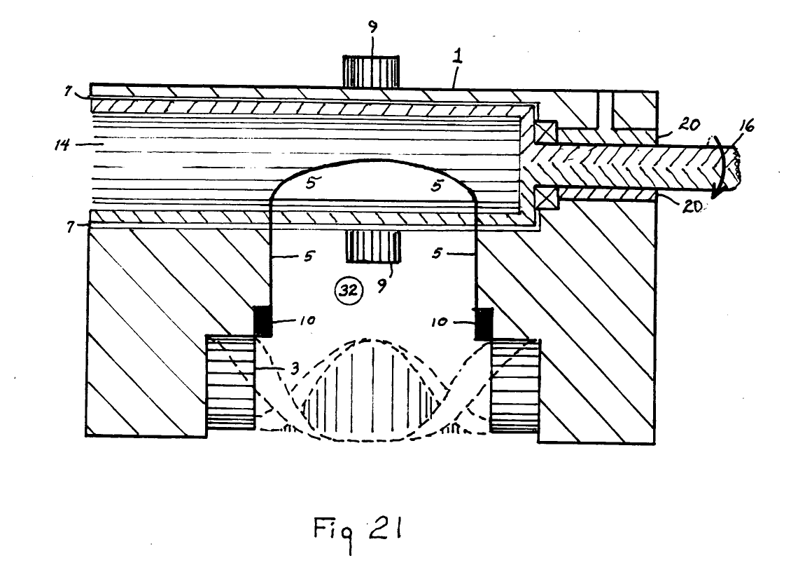

FIG. 21 is a sectional view of the intake rotary valve¹⁴ installed in the cylinder head.¹ Stationary lobes³ in the cylinder head¹ are shown below the poppet valve seat which is below the intake port.⁵ Lobes³ in the cylinder head are partially shown using the required pen and ink, and style of lines. The combustion chamber, is the central part of the drawing without hatchmarks.

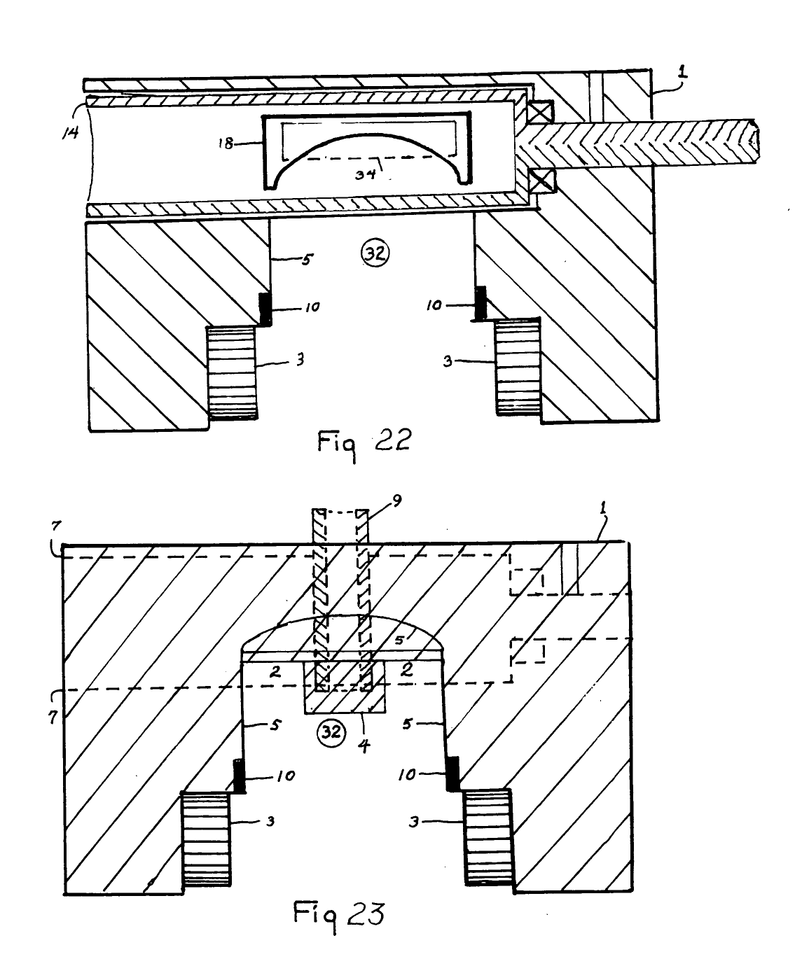

FIG. 22 is a side sectional at the intake rotary valve.¹⁴ The same view as FIG. 21 with a view of the intake rotary valve port 18.

FIG. 23 is sectioned at the poppet valve guide⁹ showing an outline of the intake rotary valve passageway⁷ in outline, without the valve. The air guide⁴ is shown mounted to, and below, the valve guide support.² Drawings of the exhaust rotary valve¹⁵ are just the opposite of FIGS. 22 and 23.

FIG. 24 is the intake rotary valve¹⁴ with the intake rotary valve port¹⁸ facing the viewer.

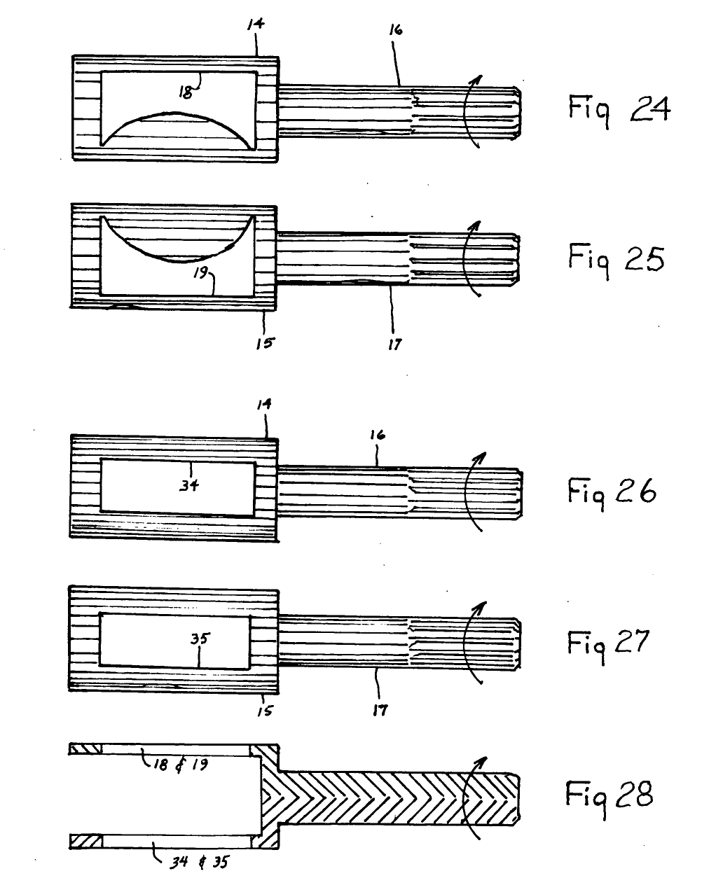

FIG. 25 is the exhaust rotary valve¹⁵ with the exhaust rotary valve port¹⁹ facing the viewer.

FIG. 26 is a rectangular port for cooling air, however, the opening may be of any design, including extending the rotary valve port to be open while the poppet valve is closed.

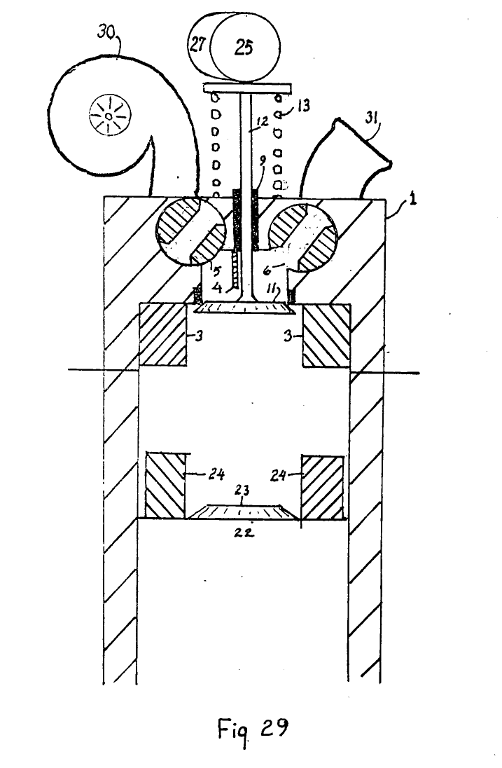

FIGS. 27 and 28 are the same as FIG. 26.

FIG. 29 The poppet valve¹¹ closes to begin compression, open position of the exhaust rotary valve¹⁵ does not effect the compression or combustion strokes. Open exhaust rotary valve allows heated air to flow into the exhaust for cooling purposes.

Sheet 13

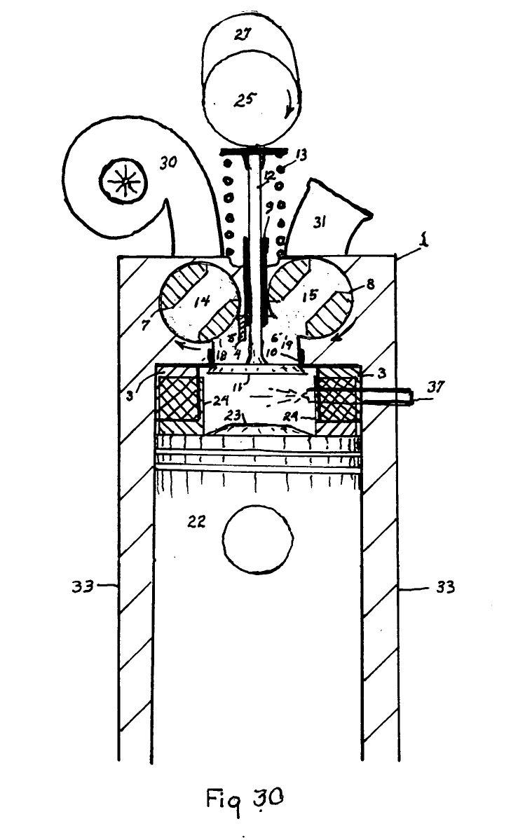

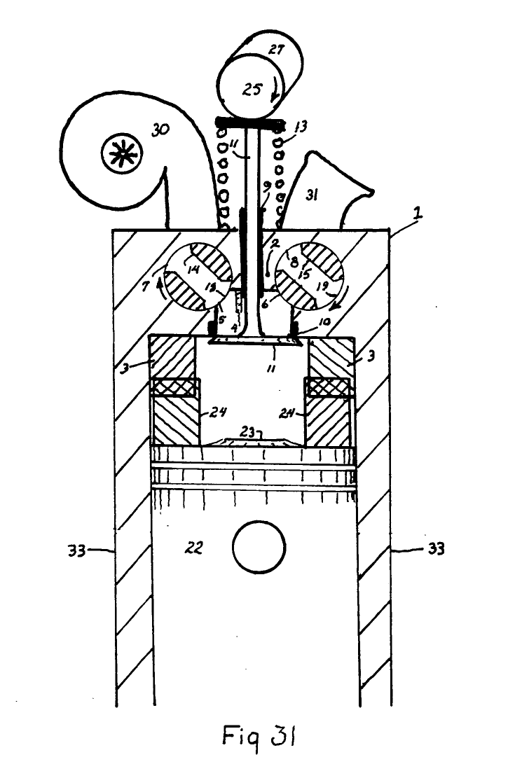

FIG. 30 illustrates that the compression stroke is complete and fuel injection begins. When the poppet valve is closed on the compression and combustion strokes, the rotary valves may be in any position without changing the function of compression and combustion.

FIG. 31 illustrates the combustion stroke in progress; poppet valve closed, isolating the combustion chamber from the manifold, and the intake rotary valve admitting compressed air into the manifold, without a vent into the exhaust rotary valve. A vent is optional after testing to determine a design for the vent.

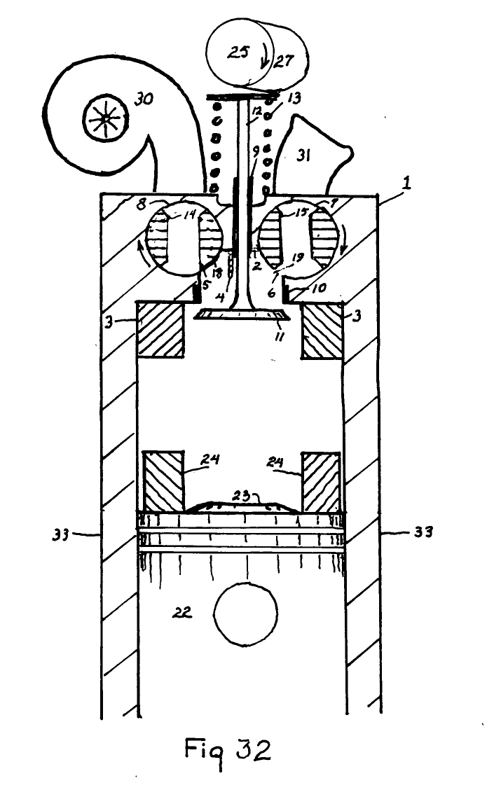

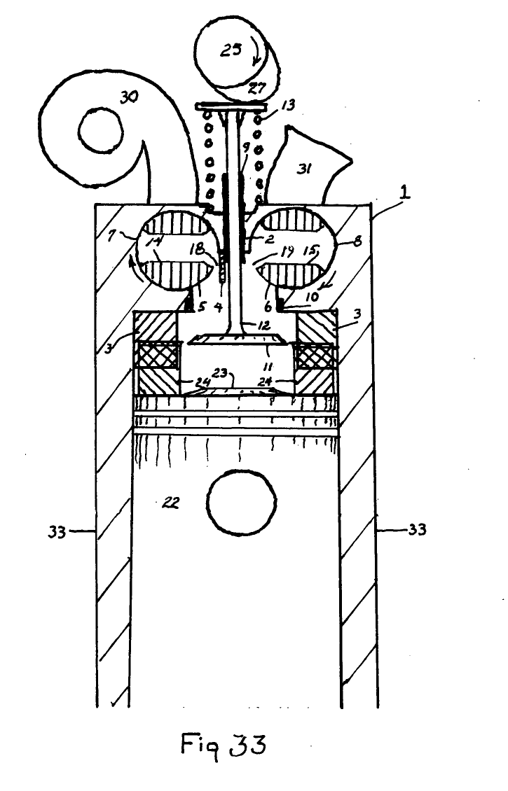

FIG. 32 as the poppet valve first opens, beginning the exhaust stroke, causing an immediate drop-in exhaust pressure as exhaust gases vacate the cylinder into the manifold, exhaust rotary valve and atmosphere. The intake rotary valve cannot be open while the exhaust rotary valve is open.

FIG. 33 illustrate the exhaust stroke when lobes begin to merge, and purge exhaust gases into the exhaust rotary valve.

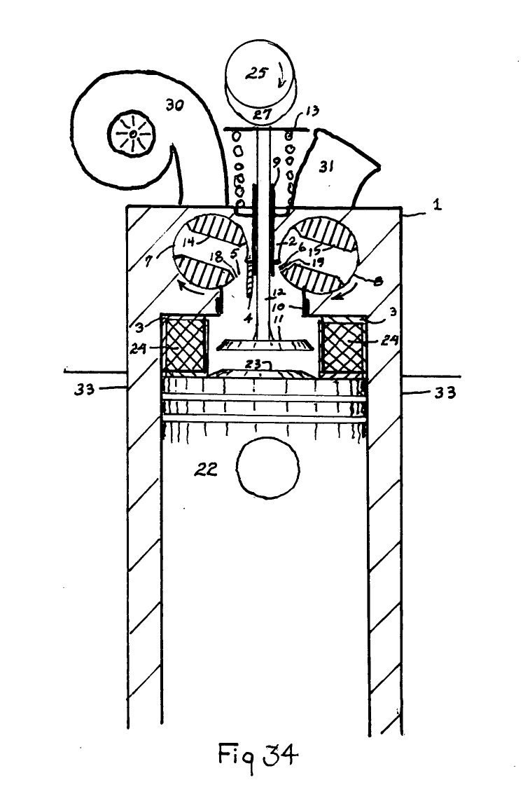

FIG. 34 illustrates the piston at top dead center, with piston and exhaust gas movement stopped. Compressed air assumes movement of exhaust gases into the exhaust rotary valve.

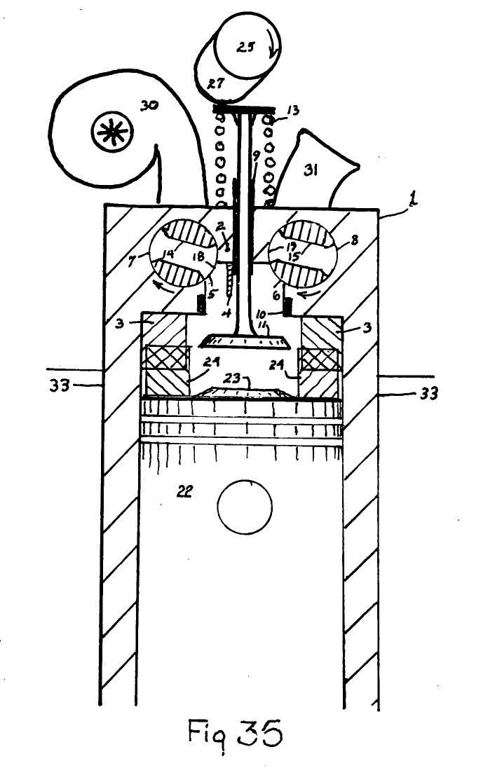

FIG. 35 illustrates the piston in downward movement, exhaust rotary valve closes at 45° after top dead center and intake rotary valve remains open until bottom dead center.

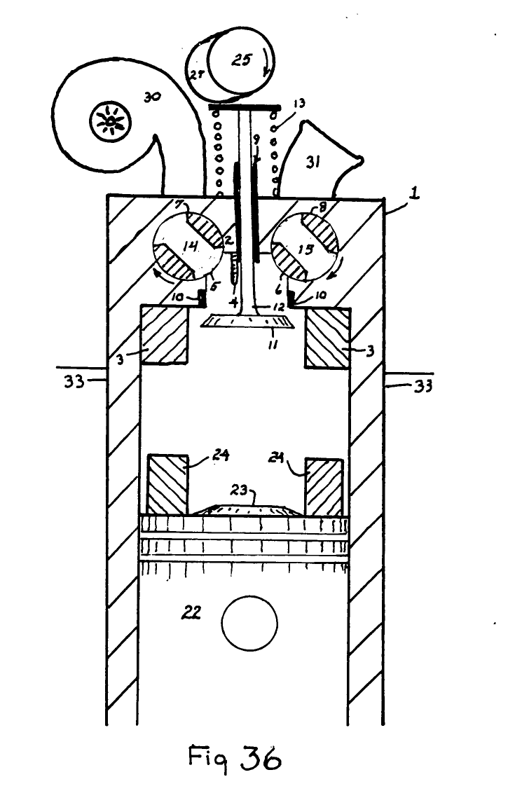

FIG. 36 illustrates intake complete as the poppet valve closes and the intake rotary valve is full open for internal cooling after the poppet valve closes. Installing a vent into the exhaust rotary valve is optional to control the volume of air through the manifold.

FIG. 37 illustrates the overhead valve as in prior art.

Sheet 21

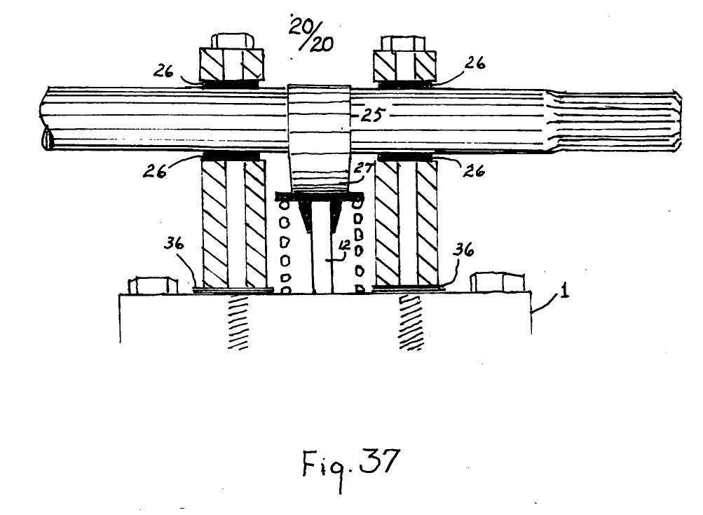

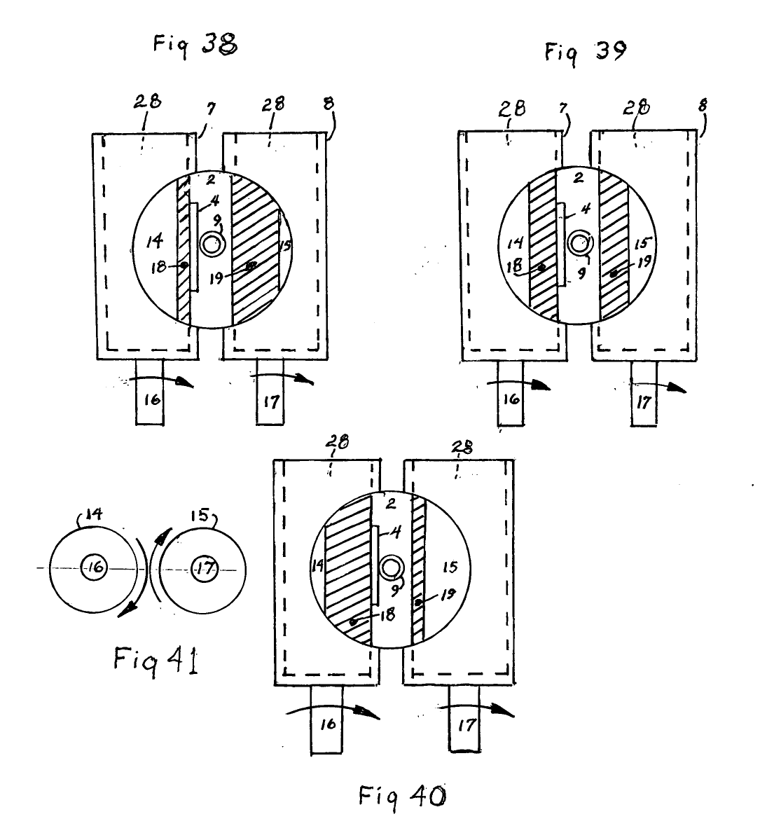

FIG. 38 is a clockwise rotation of the rotary valves. The intake valve is shown opening as in FIG. 38, and the exhaust valve is closing as in FIG. 40. FIG. 39 is the valve positions when the piston is at top dead center.

FIG. 41 illustrates how both valves turn clockwise, but the arrows indicating their rotation makes it appear that they are in opposite rotation.

Sheet 22

FIG. 42 illustrates the overlap of exhaust and intake strokes. The exhaust rotary valve¹⁵ opens at bottom dead center^{A} and closes at 45° after top dead center^{B}. The intake rotary valve¹⁴ opens at 45° before top dead center^{C} and closes at bottom dead center,^{A} causing the overlap that provides compressed air to purge exhaust gases.

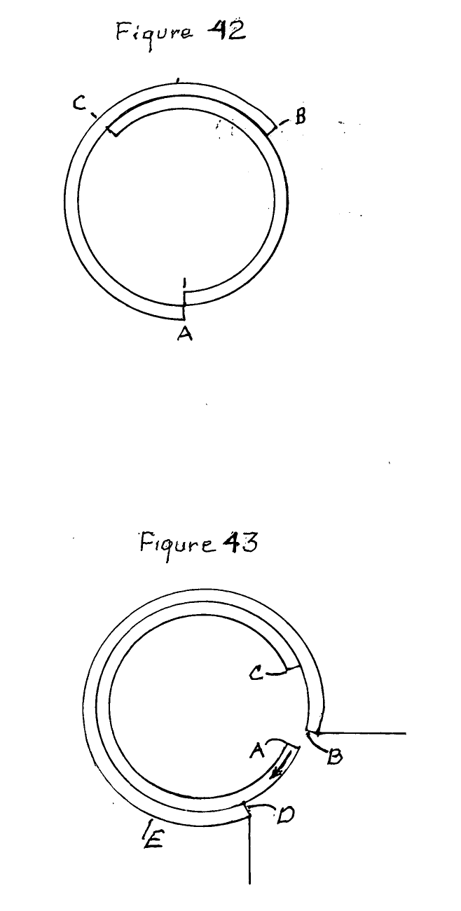

FIG. 43—For the rotating port^{A,C} to close the stationary port,^{B,D} the leading edge^{A} that opened the port at point B, must proceed to point E. Point C will have proceeded to point D to close the valve.

Sheet 23

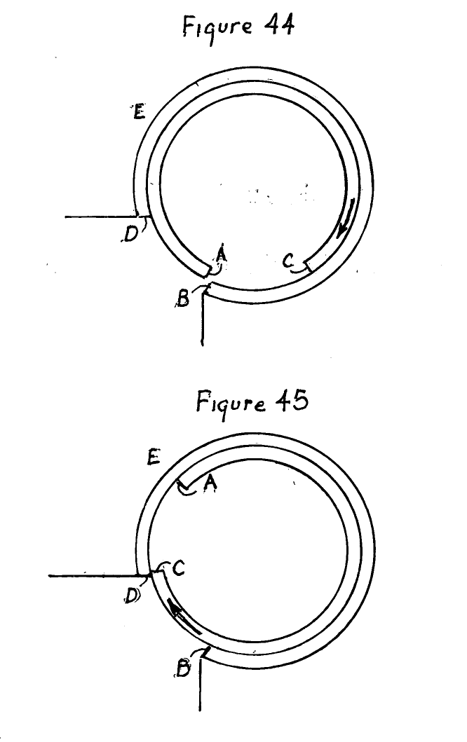

FIGS. 44 and 45 show the exhaust rotary valve¹⁵ at the beginning and end of the exhaust stroke.

FIG. 44 opens the valve when point A proceeds past point B, shown partly open. The valve continues to open as point A approaches point D, and at that point the valve is full open and the exhaust stroke ends as the poppet valve closes. Point A proceeds to point E as the trailing edge, point C, is at point D. At this point compressed air is used for cooling purposes by modeling the valve at point C to extend the duration of valve opening until the intake valve is in position, then the exhaust valve must close.

1. An engine improvement for four cycle, reciprocating piston, internal combustion diesel engines with one poppet valve equipped with air compressor that alters the ratio of air, fuel and exhaust gases to improve aspiration and combustion, and with lobes of the hill and valley design constructed onto the piston crown and into the cylinder head is a novel feature of the invention, as they merge without contact creating compression and turbulence on the compression stroke to mix fuel and air for combustion by forming a cylinder shaped combustion chamber surrounded by lobes at top dead center that may be designed with various dimensions of length and diameter and still be defined as a cylinder shaped combustion chamber, and lobes merge on the exhaust stroke, with the poppet valve open, expelling exhaust gases from between the lobes, into, and through the combustion chamber, into the manifold and through the exhaust rotary valve, with assistance from and in unison with compressed air, to complete the purge:

2. An engine improvement as claimed in claim 1, I claim that the cylinder shaped design of the combustion chamber creates turbulence because of the circular design of said chamber, with the lobes, at top dead center, piston position.

3. An engine improvement as claimed in claim 1. I claim that with the combustion chamber cylindrical in design, clearance between the outer parameter of the poppet valve head and the inner wall of the lobes, is uniform, and the clearance between the lobes of the piston crown and the stationary lobes in the cylinder head at their nearest point is uniform, therefore, the turbulence created between the moving parts and the stationary parts is equal in all areas of the combustion chamber during the compression stroke.

4. An engine improvement as claimed in claim 1, I claim that the cylinder shaped design of the combustion chamber causes equal turbulence throughout the combustion chamber for mixing fuel and air at the time of fuel injection.

5. An engine improvement as claimed in claim 3, I claim that said lobes of the hill and valley design will cause vortex turbulence by altering the fuel injector angle, to inject off center, to right or left, in a desired direction, to create said vortex as combustion expansion forces rotation within the cylinder wall, cylinder head and piston crown.

6. An engine improvement, as claimed in claim 3, I claim that said lobes of the hill and valley design, function with vortex turbulence created by constructing the mating lobe surfaces, to point at an angle, off center, to right or left, of the piston center to cause movement of air in that direction from between said lobe surfaces when they merge during compression.

7. An engine improvement as claimed in claim 3, I claim that said hill and valley lobe design will function when the poppet valve is moved off center, on the same vertical axis as the piston, requiring said lobes to be larger on one side of the poppet valve and smaller on the other side, and requiring that rotary valve ports be modified to the adjusted size of said rotary valves.

8. An engine improvement as claimed in claim 1, I claim that exhaust gases are purged from the combustion chamber of the end of the exhaust stroke, beginning when the piston lobes begin to merge with cylinder head lobes and piston movement forces exhaust gases into the exhaust rotary valve until piston movement stops at top dead center
and exhaust gas movement is assumed by compressed air being admitted timely through the intake rotary valve into the manifold, around the air guide, forcing remaining exhaust gases from the combustion chamber and manifold into the exhaust rotary valve that closes at 45° after top dead center to end the purge and exhaust stroke.

9. I claim that a conduit is formed to contain and control the movement of compressed air and exhaust gases, with said conduit comprised of the cylinder, piston, combustion chamber, and the manifold, which is part of the cylinder head containing the poppet valve, intake rotary valve, exhaust rotary valve and air guide, with the supercharger mounted over the intake air entrance of the cylinder head and the turbocharger mounted to the exhaust exit from the cylinder head, both providing compressed air and the turbocharger is optional.

10. An engine improvement as claimed in claim 9, I claim that a compact arrangement of valves within said conduit forms the manifold, and is a novel feature of the invention, being comprised of the poppet valve, exhaust rotary valve, and intake rotary valve in addition to the air guide, with the valves manipulating the movement of said compressed air and said exhaust gases inside said manifold, and the function of said air guide is totally within the manifold. Preventing compressed air from assuming the path of least resistance out of the manifold.

11. An engine improvement as claimed in claim 9, I claim that said intake rotary valve opens on the exhaust stroke after exhaust pressure has dropped below that of compressed air, and works in unison with the exhaust rotary valve while manipulating the movement of air and exhaust gases in the manifold during the purge of exhaust gases

12. An engine improvement as claimed in claim 11, I claim that said air guide directs compressed air within the manifold, around the air guide and to the poppet valve head to prevent compressed air from proceeding on the path of least resistance into the exhaust rotary valve; and compressed air turns 180° at the poppet valve head and continues movement behind final exhaust gases, forcing said gases into the exhaust rotary valve.

13. An engine improvement as claimed in claim 12, I claim that the air guide is constructed with vents, as small holes, through the air guide and/or holes between the air guide and the cylinder head it is constructed to, to prevent hot spots in the cylinder head and air pockets in the manifold.

14. I claim that the rotary valves function below the range of high pressure common inside a diesel or gasoline engine combustion chamber on the compression and combustion strokes because of the closed poppet valve,
and that the rotary valves function required an air compressor to complete the purge of exhaust gases, after top dead center piston position
and the range of air pressure acts as a buffer zone type of seal preventing leakage between the exhaust rotary valve passageway
and the exhaust rotary valve body allows the rotary valves to function without an air tight seal of poppet valve quality

15. An engine improvement as claimed in claim 14, I claim that the rotary valve ports, both intake and exhaust, by opening and closing the intake and exhaust passageway ports, controls the timing of air and exhaust gases in and out of the manifold and combustion chamber and is a novel feature of the invention.

16. An engine improvement as claimed in claim 14, I claim that the flow of air from the supercharger is converted to an interrupted movement of air, and timed at the intake rotary valve port, passing air into the intake passageway port.

17. An engine improvement as claimed in claim 8, I claim that compressed air entering through the intake rotary valve is vital to the function of the exhaust rotary valve by preventing a backflow of exhaust gases into the manifold.

18. An engine improvement as claimed in claim 14, I claim that on the compression and combustion strokes, when the poppet valve is closed, the intake and exhaust rotary valves are open for the passage of air through the manifold for cooling purposes, and for this adjustment, rotary valve ports are enlarged to lengthen the duration of air entering and exiting the manifold, and, if so designed, use the heated air for combustion purposes or remove to the atmosphere.

19. An engine improvement as claimed in claim 14, I claim that the invention reduces the amount of exhaust gases recycled into the intake stroke by reducing the amount of exhaust gases trapped in the combustion chamber at the end of the exhaust stroke.
by purging with compressed air causing an increased amount of air and a reduced amount of exhaust gases on the next intake stroke, and recognizing that all exhaust gases cannot be removed from between the poppet valve head and piston crown, and between the piston and cylinder wall,
the success of purging occurs in a succession of strokes that dilute the remaining gases, and
remaining exhaust gases reach their level of interference with air, as gases that will not burn again, being mixed with fuel and air that will burn completely, without any interference.
and with the purge completed, exhaust gases are reduced and replaced with air, increasing the volume of air for combustion with fuel.

20. An engine improvement as claimed in claim 15, I claim that adjusting the rotary valves is accomplished by adjusting timing belts, timing gears or timing chains or enlarging or reducing the port opening in the valve body; and adjusting the manifold ports is by enlarging or reducing the port opening.
